(19) United States
(12) Patent Application Publication
(10) Pub. No.: US 2004/0032537 A1
(43) Pub. Date: Feb. 19, 2004

(54) Multiple selection in a wide-band receiver for specific tuning to each of the connected TV-Sets, audio-receivers or other entertainment-devices

(76) Inventor: Frederick Bluemel, Fort Salonga, NY (US)

Correspondence Address: Frederick Bluemel, 18 Williamsburg Dr., Northport, NY, 11768-2548, US

(21) Appl. No.: 10/218,086

(22) Filed: Aug. 13, 2002

(51) Int. Cl. H04N 5/46

(52) U.S. Cl. 348/729; 348/725

(57) ABSTRACT

This invention allows to connect TV-Sets, Audio-Receivers or other Entertainment-Devices to be connected to the receiver or converter of a satellite dish or cable network using only this single electronic apparatus with multiple output-ports and controlling the connected device using its inherent control mechanisms. The electronic apparatus functions in a master slave mode and adjusts automatically for the desired frequency or channel selection of the device connected to its port. No other control devices are required for the electronic apparatus to operate as the slave for the set connected to its ports.

### SPECIFICATION

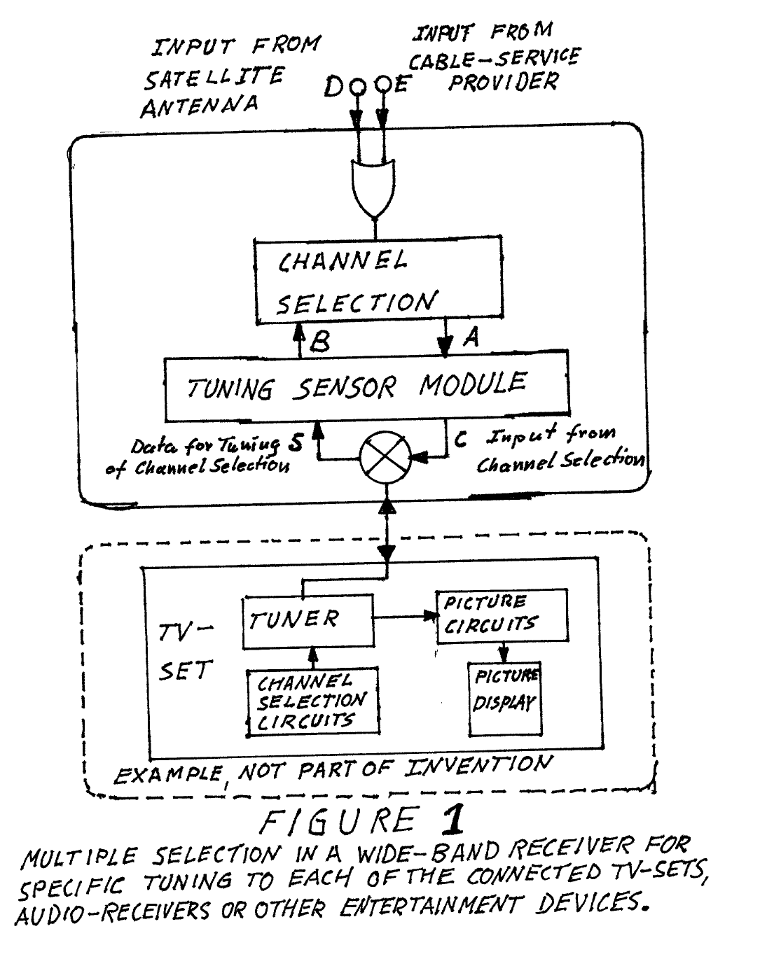

The purpose of the invention is to eliminate the need for separate dedicated Receivers for each device connected to a network, either of satellite origin or a cable network. Instead, a Wide-Band Receiver, shown in FIG. 1, CHANNEL SELECTION, with special tuning electronics will select the frequency band or channel needed for the device connected to this port. The function of the TUNING SENSOR MODULE, also shown in FIG. 1, is to detect the channel or frequency band and provide this information for channel selection. The input to the channel selection can originate either from a SATELLITE ANTENNA or a CABLE SERVICE PROVIDER. The data flow to the connected device, see FIG. 1, is through the channel selection “A” through the tuning sensor module “C”, through a switch to the connected device. The switch multiplexes between information going to the connected device “C” and the “S” data for tuning channel selection which is analyzed and processed for information “B” and transferred to the channel selection.

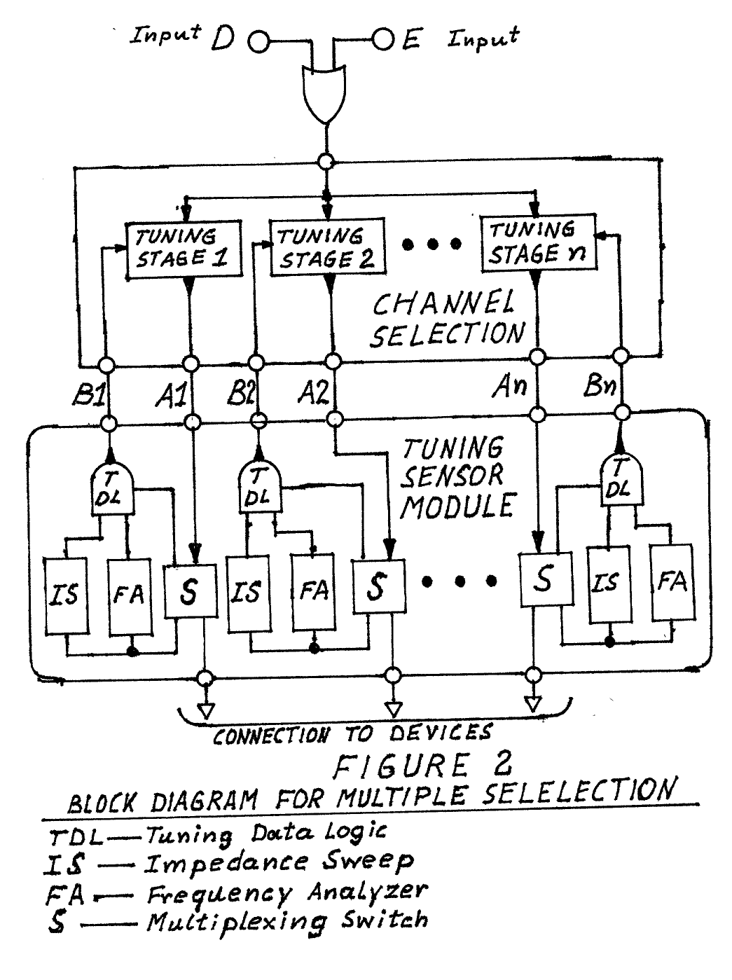

Multiple devices can be connected and serviced by the CHANNEL SELECTION module in conjunction with the TUNING SENSOR MODULE, see FIG. 2. Both use a modular design concept, in effect, the connection of more receiving devices only requires the addition of the corresponding “Tuning Stages” and “Tuning Sensor Modules”, which as plug-in-modules are inserted in spaces provided. The addition of these modules can be reported to the effected modules through switches such that the additionally connected devices are provided with the tuning data for channel/frequency selection.

### BACKGROUND OF THE INVENTION

The presently available technology for connecting TV-Sets, Audio-Receivers or other devices displaying video or acoustic signals received from a cable network or a satellite, via a dish with converter, require a separate receiver for each device connected to the supply-network or dish. In addition to this, the control apparatus for the connected device and the signal processing receivers are different. To select different channels of the cable network or the dish processor requires one type of apparatus while another apparatus controls the connected device. This is especially cumbersome when selections between the cable network or dish converter and conventional or local service providers are required. In addition it is necessary to have the cable network or satellite receiver in close vicinity to the connected device (TV-Set, Audio-Receiver or other digital processing device).

The invention eliminates the requirement for having TWO CONTROL APPARATUSES for one device connected to a Cable-Network, a Dish-Converter or other service providers. The original control apparatus for the connected device is sufficient to select the desired channel or function for the connected device. This is accomplished by detecting the tuning channel or frequency of the connected device and presenting this information to an originally wide-band receiver which is then tuned to the corresponding channel or frequency required by the connected device.

### BRIEF SUMMARY OF THE INVENTION

The purpose of the invention is to simplify operation, reduce cost and energy consumption by eliminating multiple front-end receivers, one for each connected device to cable networks, dish converters or other service providers. One common front-end receiver with multiple tuning stages services all connected devices.

### DETAILED DESCRIPTION OF THE INVENTION

The block diagram of FIG. 1 depicts the two basic modules which are required for each connected device (TV-Set or Audio/FM-Receiver or other digital device. The input to the channel selection could be either a converted signal from a satellite antenna or from a cable service provider.

A more detailed block diagram is shown a FIG. 2, again showing the two basic functions of CHANNEL SELECTION and TUNING SENSOR MODULE. The channel selection can be expanded for stages I through stage n to provide for additional devices when connected. The same applies for tuning sensor module, which also expands for additionally, connected devices. The communication between both modules is through data transfer shown as connections A1, B1 expandable to An, Bn. The A-Date consists of the actual information as provided by the E-Input or D-Input, selected for the channel required by the connected device. The B-Data is the control data, which tells the tuning stages which channel or frequency band is required for the connected device.

The tuning stages can be designed either as tunable L/C circuits with continues tuning over the total frequency band or multiple fixed tuned stages which are then selected. The tunable L/C circuits are either tuned with variable L-inductors or variable C-capacitors. In either case, B-data determines the position of the component. For multiple fixed tuned stages, the B-data determines which stage/channel is to be selected. In this case only the number of channels which are required by the device, i.e. the number of channels desired by the customer need to be provided in this tuning stage. This could proof to be more economical than a variable tuning over the total frequency band. The actual method of tuning is not part of this invention since it is commercially available as is which form the B-data uses for its coding in binary numbers or special codes.

The TUNING SENSOR MODULE consists of four functional circuits with clock timing for each. The four circuits are: Tuning Data Logic (TDL), Impedance Sweep (IS), Frequency Analyzer (FA), Multiplexing Switch (S).

The TDL provides the clock timing for the modules and in its simplest form decides which channel is to be selected. In this case and/or-logic will suffice. More advanced functions will require a microprocessor which decides on the channel selection. The microprocessor will have in its preprogrammed memory the total number of channels required for this particular device and which channels the device connected to this port requires. This will greatly facilitate the sensing process since only truly connected channels need to be investigated. Furthermore, a probability function can be incorporated in the software for the microprocessor, which will establish a probability function for channel hopping such that only the channel with the higher probability needs to be analyzed by the IS/FA-modules.

The IS is quarried by the TDL to confirm if the channel, which was selected by probability calculations of the TDL, is indeed the channel the connected device is tuned to. In essence, it measures the impedance of the device for the frequency which was selected by the TDL and adjusted in the IS through tuning of the oscillator, and if confirmed reports this to the TDL. The Impedance Bridge for measuring is set to give yes or no control signals within a certain predetermined range to the TDL.

The function of the FA is to detect the frequency of the local oscillator (LO) of the connected device. This function is secondary to the determination by the IS. If a conclusive decision was made by the IS, then the TDL will not initiate a request to the FA for frequency analysis. If a frequency analysis must be performed, then the LO frequency is reported to the TDL which determines channel selection on account of known IF for the device.

The switch S multiplexes functions between the signals “A” and “B”, including all additionally connected devices up to “An” and “Bn”, with an extra switch per device. The multiplex timing is controlled by the TDL. The quiescent mode of the switch is for feeding either video or modulated signals, depending on which type of device is at this port, to the device. The TDL periodically queries the connected device for the channel frequency. If no change is indicated then no further action is required and the tuning stage in the CHANNEL SELECTION will remain as adjusted. If a change is detected then the TDL initiates tuning analysis through either the Impedance Sweep or Frequency Analyzer or both. The switch S will then feed the signal to the IS and FA as required for analysis which is subsequently reported to the TDL. The TDL now feeds the new tuning data to the corresponding tuning stage, which adjusts for the revised channel frequency.

1) What I claim as my invention is an electronic apparatus which eliminates the need for using a separate receiver or converter for each TV-Set or Audio-Receiver or other Entertainment-Device which is connected to either a Satellite converter or a Cable Network.

2) What I claim as my invention is a CHANNEL SELECTION apparatus consisting of multiple parallel tuning stages which are tuned each separately to the frequencies or channels selected by the TV-Set or Audio-Receiver or other Entertainment-Device connected to this particular port and the tuning stages being controlled by the TUNING SENSOR MODULE.

3) What I claim as my invention is a means of detecting the channel selection of the connected TV-Set or Audio-Receiver or other Entertainment-Device and changes in the channel selection of these devices and selecting the corresponding channel frequency for the tuning stages.

4) What I claim as my invention is the use of an electronic apparatus, which eliminates the need for multiple controls for the TV-Set or Audio-Receiver or other Entertainment-Devices due to the use of separate receivers or converters.
